(19) United States
(12) Patent Application Publication
(10) Pub. No.: US 2022/0180367 A1
(43) Pub. Date: Jun. 9, 2022

(54) BEHAVIOR CLASSIFICATION AND PREDICTION THROUGH TEMPORAL FINANCIAL FEATURE PROCESSING WITH RECURRENT NEURAL NETWORK

(71) Applicant: International Business Machines Corporation, Armonk, NY (US)

(72) Inventors: Guandong Zhu, Raleigh, NC (US); Yi-Hui Ma, Mechanicsburg, PA (US); Shuyan Lu, Cary, NC (US); Junhui Wang, Cary, NC (US); Chuan Ran, Morrisville, NC (US)

(21) Appl. No.: 17/115,818

(22) Filed: Dec. 9, 2020

(51) Int. Cl. G06Q 20/40; G06Q 20/38; G06N 3/08; G06K 9/62

(52) U.S. Cl. CPC G06Q 20/4016; G06K 9/6298; G06N 3/08; G06Q 20/385

(57) ABSTRACT

A system, computer program product, and method are presented for classifying behaviors and predictions through processing temporal financial features with a recurrent neural network (RNN). The method includes receiving, by a RNN model, first financial transaction events. The method also includes classifying non-fraudulent behavioral patterns and potentially fraudulent behavioral patterns resident within the first financial transaction events and training the RNN model therewith. The method further includes receiving, by the RNN model, second financial transaction events over a predetermined period of time. The method also includes normalizing the second financial transaction events, including partitioning the predetermined period of time into a plurality of first equal temporal segments. Some of the plurality of first equal temporal segments are representative of the second financial transaction events residing therein. The method further includes predicting a labeling of the second financial transaction events with a behavior pattern of one of non-fraudulent and potentially fraudulent.

### BACKGROUND

The present disclosure relates to behavior classifications and predictions, and, more specifically, to classifying behaviors and predictions through processing temporal financial features with a recurrent neural network.

Many known recurrent neural networks (RNNs) include general purpose systems that are configured to detect historical temporal patterns and make predictions about future patterns. The temporal processing may include learning temporal sequences, performing inference, recognizing temporal sequences, predicting temporal sequences, labeling temporal sequences, and temporal pooling. For example, at least some of the known RNNs are configured to use predictive models for credit scoring in financial services that factor in a customer's credit history and data to predict the likeliness that the customer will, or will not, default on a loan. Also, some known RNNs are configured to ingest health-related data for patients and predict future health events for those patients. Further, some known RNNs are configured for real-time fraud detection, including potential fraud through multiple interleaving accounts. Moreover, some RNNs are configured for future stock price prediction based on historical stock prices. Some known RNNs configured for fraud detection use weighted data, where the weighting of the inputs is such that more recent transactions have higher weights.

### SUMMARY

A system, computer program product, and method are provided for classifying behaviors and predictions through processing temporal financial features with a recurrent neural network.

In one aspect, a computer system is provided for classifying behaviors and predictions through processing temporal financial features with a recurrent neural network. The system includes one or more processing devices and at least one memory device operably coupled to the one or more processing devices. The system also includes a recurrent neural network (RNN) model resident within the at least one memory device. The one or more processing devices are configured to receive, by the RNN model, for one or more first target focal objects, one or more first sequential series of financial transaction events and determine non-fraudulent and potentially fraudulent financial transactions resident within the one or more first sequential series of financial transaction events. The one or more processing devices are also configured to classify at least a first portion of the one or more first sequential series of financial transaction events as a non-fraudulent behavioral pattern and classify at least a second portion of the one or more first sequential series of financial transaction events as a potentially fraudulent behavioral pattern. The one or more processing devices are further configured to train the RNN model with the non-fraudulent behavioral pattern and the potentially fraudulent behavioral pattern and receive, by the RNN model, for a second target focal object, a second sequential series of financial transaction events, at least a portion of the second sequential series of financial transaction events occur over a first predetermined period of time. The one or more processing devices are also configured to normalize the second sequential series of financial transaction events, including partitioning the first predetermined period of time into a plurality of first equal temporal segments. At least a portion of the plurality of first equal temporal segments are representative of one or more portions of the second financial transaction events residing therein. The one or more processing devices are further configured to predict a labeling of the one or more portions of the second financial transaction events with a behavior pattern of one of non-fraudulent and potentially fraudulent.

In another aspect, a computer program product is provided for classifying behaviors and predictions through processing temporal financial features with a recurrent neural network. The computer program product includes one or more computer readable storage media, and program instructions collectively stored on the one or more computer storage media. The product also includes program instructions to receive, by a recurrent neural network (RNN) model, for one or more first target focal objects, one or more first sequential series of financial transaction events. The product further includes program instructions to program instructions to determine non-fraudulent and potentially fraudulent financial transactions resident within the one or more first sequential series of financial transaction events. The product also includes program instructions to classify at least a first portion of the one or more first sequential series of financial transaction events as a non-fraudulent behavioral pattern. The product further includes program instructions to classify at least a second portion of the one or more first sequential series of financial transaction events as a potentially fraudulent behavioral pattern. The product also includes program instructions to train the RNN model with the non-fraudulent behavioral pattern and the potentially fraudulent behavioral pattern. The product further includes program instructions to receive, by the RNN model, for a second target focal object, a second sequential series of financial transaction events, at least a portion of the second sequential series of financial transaction events occur over a first predetermined period of time. The product also includes program instructions to normalize the second sequential series of financial transaction events, including partitioning the first predetermined period of time into a plurality of first equal temporal segments. At least a portion of the plurality of first equal temporal segments are representative of one or more portions of the second financial transaction events residing therein. The product further includes program instructions to predict a labeling of the one or more portions of the second financial transaction events with a behavior pattern of one of non-fraudulent and potentially fraudulent.

In yet another aspect, a computer-implemented method is provided for classifying behaviors and predictions through processing temporal financial features with a recurrent neural network. The method includes receiving, by a recurrent neural network (RNN) model, for one or more first target focal objects, one or more first sequential series of financial transaction events. The method also includes determining non-fraudulent and potentially fraudulent financial transactions resident within the one or more first sequential series of financial transaction events. The method further includes classifying at least a first portion of the one or more first sequential series of financial transaction events as a non-fraudulent behavioral pattern. The method also includes classifying at least a second portion of the one or more first sequential series of financial transaction events as a potentially fraudulent behavioral pattern. The method further includes training the RNN model with the non-fraudulent behavioral pattern and the potentially fraudulent behavioral pattern. The method further includes receiving, by the RNN model, for a second target focal object, a second sequential series of financial transaction events. At least a portion of the second sequential series of financial transaction events occur over a first predetermined period of time. The method also includes normalizing the second sequential series of financial transaction events, including partitioning the first predetermined period of time into a plurality of first equal temporal segments. At least a portion of the plurality of first equal temporal segments are representative of one or more portions of the second financial transaction events residing therein. The method further includes predicting a labeling of the one or more portions of the second financial transaction events with a behavior pattern of one of non-fraudulent and potentially fraudulent.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a schematic diagram illustrating a cloud computer environment, in accordance with some embodiments of the present disclosure.

FIG. 2 is a block diagram illustrating a set of functional abstraction model layers provided by the cloud computing environment, in accordance with some embodiments of the present disclosure.

FIG. 3 is a block diagram illustrating a computer system/server that may be used as a cloud-based support system, to implement the processes described herein, in accordance with some embodiments of the present disclosure.

FIG. 4 is a block diagram illustrating a computer system configured to classify behaviors and predictions through processing temporal financial features with a recurrent neural network, in accordance with some embodiments of the present disclosure.

FIG. 5A is a flowchart illustrating a process for leveraging an RNN to classify behaviors and predictions through processing temporal financial features, in accordance with some embodiments of the present disclosure.

FIG. 5B is a continuation of the flowchart from FIG. 5A, in accordance with some embodiments of the present disclosure.

FIG. 5C is a continuation of the flowchart from FIG. 5B, in accordance with some embodiments of the present disclosure.

FIG. 5D is a continuation of the flowchart from FIG. 5C, in accordance with some embodiments of the present disclosure.

FIG. 6 is a graphical representation illustrating an example normalized timeline and the respective temporal buckets, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments. In addition, it will be appreciated that, although specific embodiments have been described herein for purposes of illustration, various modifications may be made without departing from the spirit and scope of the embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

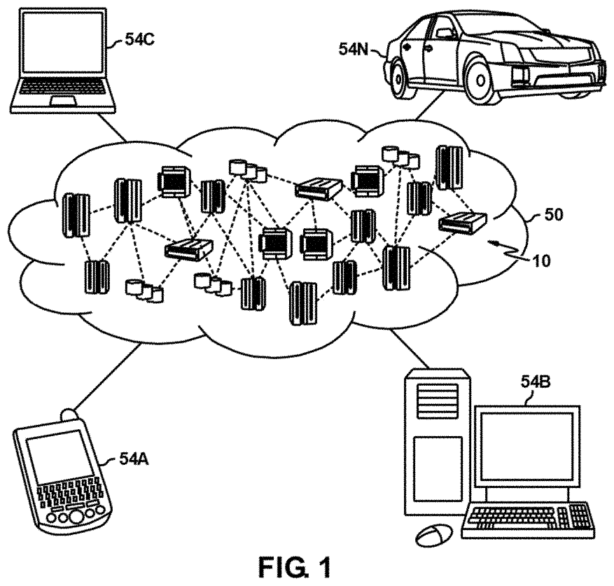

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

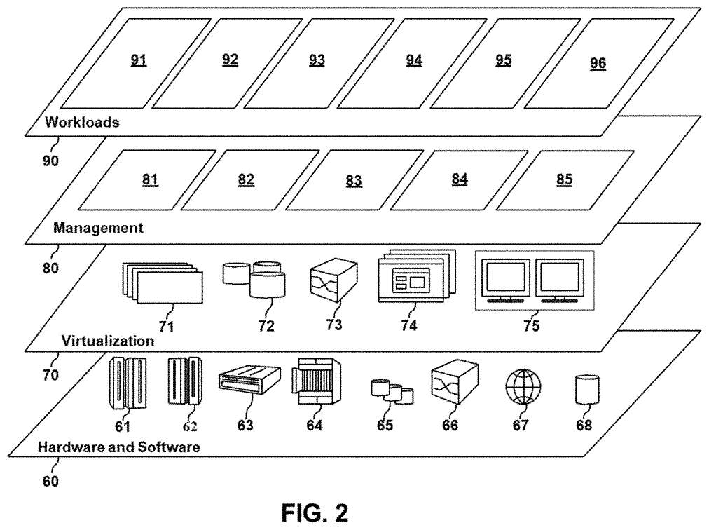

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and to behavior classifications and predictions 96.

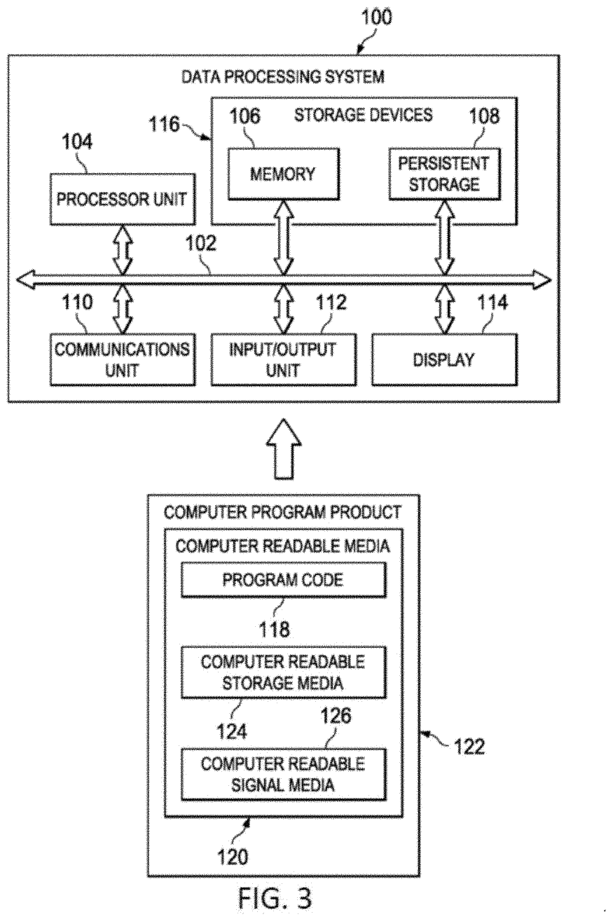

Referring to FIG. 3, a block diagram of an example data processing system, herein referred to as computer system 100, is provided. System 100 may be embodied in a computer system/server in a single location, or in at least one embodiment, may be configured in a cloud-based system sharing computing resources. For example, and without limitation, the computer system 100 may be used as a cloud computing node 10.

Aspects of the computer system 100 may be embodied in a computer system/server in a single location, or in at least one embodiment, may be configured in a cloud-based system sharing computing resources as a cloud-based support system, to implement the system, tools, and processes described herein. The computer system 100 is operational with numerous other general purpose or special purpose computer system environments or configurations. Examples of well-known computer systems, environments, and/or configurations that may be suitable for use with the computer system 100 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The computer system 100 may be described in the general context of computer system-executable instructions, such as program modules, being executed by the computer system 100. Generally, program modules may include routines, programs, objects, components, logic, data structures, and so on that perform particular tasks or implement particular abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, the computer system 100 is shown in the form of a general-purpose computing device. The components of the computer system 100 may include, but are not limited to, one or more processors or processing devices 104 (sometimes referred to as processors and processing units), e.g., hardware processors, a system memory 106 (sometimes referred to as a memory device), and a communications bus 102 that couples various system components including the system memory 106 to the processing device 104. The communications bus 102 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer system 100 typically includes a variety of computer system readable media. Such media may be any available media that is accessible by the computer system 100 and it includes both volatile and non-volatile media, removable and non-removable media. In addition, the computer system 100 may include one or more persistent storage devices 108, communications units 110, input/output (I/O) units 112, and displays 114.

The processing device 104 serves to execute instructions for software that may be loaded into the system memory 106. The processing device 104 may be a number of processors, a multi-core processor, or some other type of processor, depending on the particular implementation. A number, as used herein with reference to an item, means one or more items. Further, the processing device 104 may be implemented using a number of heterogeneous processor systems in which a main processor is present with secondary processors on a single chip. As another illustrative example, the processing device 104 may be a symmetric multiprocessor system containing multiple processors of the same type.

The system memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The system memory 106, in these examples, may be, for example, a random access memory or any other suitable volatile or non-volatile storage device. The system memory 106 can include computer system readable media in the form of volatile memory, such as random access memory (RAM) and/or cache memory.

The persistent storage 108 may take various forms depending on the particular implementation. For example, the persistent storage 108 may contain one or more components or devices. For example, and without limitation, the persistent storage 108 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the communication bus 102 by one or more data media interfaces.

The communications unit 110 in these examples may provide for communications with other computer systems or devices. In these examples, the communications unit 110 is a network interface card. The communications unit 110 may provide communications through the use of either or both physical and wireless communications links.

The input/output unit 112 may allow for input and output of data with other devices that may be connected to the computer system 100. For example, the input/output unit 112 may provide a connection for user input through a keyboard, a mouse, and/or some other suitable input device. Further, the input/output unit 112 may send output to a printer. The display 114 may provide a mechanism to display information to a user. Examples of the input/output units 112 that facilitate establishing communications between a variety of devices within the computer system 100 include, without limitation, network cards, modems, and input/output interface cards. In addition, the computer system 100 can communicate with one or more networks such as a local area network (LAN), a general wide area network (WAN), and/or a public network (e.g., the Internet) via a network adapter (not shown in FIG. 3). It should be understood that although not shown, other hardware and/or software components could be used in conjunction with the computer system 100. Examples of such components include, but are not limited to: microcode, device drivers, redundant processing units, external disk drive arrays, RAID systems, tape drives, and data archival storage systems.

Instructions for the operating system, applications and/or programs may be located in the storage devices 116, which are in communication with the processing device 104 through the communications bus 102. In these illustrative examples, the instructions are in a functional form on the persistent storage 108. These instructions may be loaded into the system memory 106 for execution by the processing device 104. The processes of the different embodiments may be performed by the processing device 104 using computer implemented instructions, which may be located in a memory, such as the system memory 106. These instructions are referred to as program code, computer usable program code, or computer readable program code that may be read and executed by a processor in the processing device 104. The program code in the different embodiments may be embodied on different physical or tangible computer readable media, such as the system memory 106 or the persistent storage 108.

The program code 118 may be located in a functional form on the computer readable media 120 that is selectively removable and may be loaded onto or transferred to the computer system 100 for execution by the processing device 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the computer system 100. In some instances, the computer readable storage media 124 may not be removable from the computer system 100.

Alternatively, the program code 118 may be transferred to the computer system 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or computer system through the computer readable signal media 126 for use within the computer system 100. For instance, program code stored in a computer readable storage medium in a server computer system may be downloaded over a network from the server to the computer system 100. The computer system providing the program code 118 may be a server computer, a client computer, or some other device capable of storing and transmitting the program code 118.

The program code 118 may include one or more program modules (not shown in FIG. 3) that may be stored in system memory 106 by way of example, and not limitation, as well as an operating system, one or more application programs, other program modules, and program data. Each of the operating systems, one or more application programs, other program modules, and program data or some combination thereof, may include an implementation of a networking environment. The program modules of the program code 118 generally carry out the functions and/or methodologies of embodiments as described herein.

The different components illustrated for the computer system 100 are not meant to provide architectural limitations to the manner in which different embodiments may be implemented. The different illustrative embodiments may be implemented in a computer system including components in addition to or in place of those illustrated for the computer system 100.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many known recurrent neural networks (RNNs) include general purpose systems that are configured to detect historical temporal patterns and make predictions about future patterns. The temporal processing may include learning temporal sequences, performing inference, recognizing temporal sequences, predicting temporal sequences, labeling temporal sequences, and temporal pooling. For example, at least some of the known RNNs are configured to use predictive models for credit scoring in financial services that factor in a customer's credit history and data to predict the likeliness that the customer will, or will not, default on a loan. Further, some known RNNs are configured for real-time fraud detection, including potential fraud through multiple interleaving accounts. Moreover, some RNNs are configured for future stock price prediction based on historical stock prices. Some known RNNs configured for fraud detection use weighted data, where the weighting of the inputs is such that more recent transactions have higher weights. As an additional example, some known RNNs are configured to ingest health-related data for patients and predict future health events for those patients, and more specifically, some of these known RNNs are configured to obtain one or more temporal sequences of health-related data and predict future health events. However, such known RNN-based mechanisms are not capable of normalizing the temporal sequences in the data to detect patterns in behavior with respect to financial transactions and associated financial procedures to predict future patterns of behavior.

A system, computer program product, and method are disclosed and described herein directed toward behavior classifications and predictions, and, more specifically, to classifying behaviors and predictions through processing temporal financial features with a recurrent neural network (RNN). The embodiments of the RNN described herein are used against temporal features in financial activities on target entities to detect and predict behaviors, patterns, and labels. The respective temporal periods are normalized to facilitate labeling different behavior patterns regardless of the times scales between particular behavioral patterns and frequencies thereof. The normalization of the temporal periods creates identically-sized temporal buckets that are fixed. For those extended temporal periods, the buckets may be grouped such that the historical data and predictions of an early set of buckets can be carried-over to the next set of buckets.

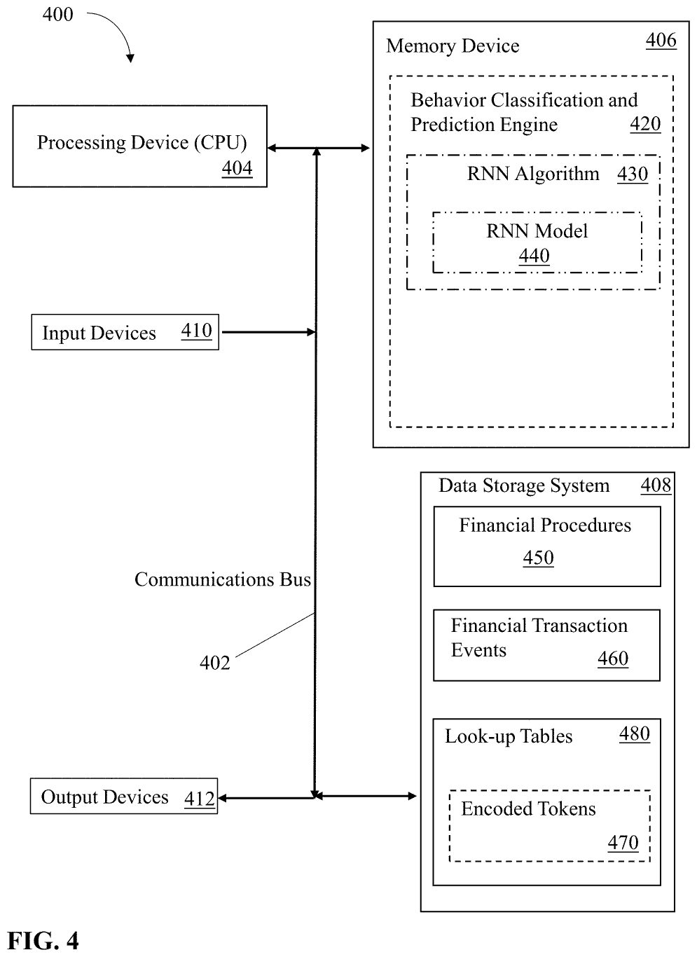

Referring to FIG. 4, a block diagram is presented illustrating a computer system, i.e., a behavior classification and prediction system 400 (hereon referred to as the system 400) configured to classify behaviors and predictions through processing temporal financial features with a recurrent neural network (RNN). The system 400 includes one or more processing devices 404 (only one shown) communicatively and operably coupled to one or more memory devices 406 (only one shown). The system 400 also includes a data storage system 408 that is communicatively coupled to the processing device 404 and memory device 406 through a communications bus 402. In one or more embodiments, the communications bus 402, the processing device 404, the memory device 406, and the data storage system 408 are similar to their counterparts shown in FIG. 3, i.e., the communications bus 102, the processing device 104, the system memory 106, and the persistent storage devices 108, respectively. The system 400 further includes one or more input devices 410 and one or more output devices 412 communicatively coupled to the communications bus 402.

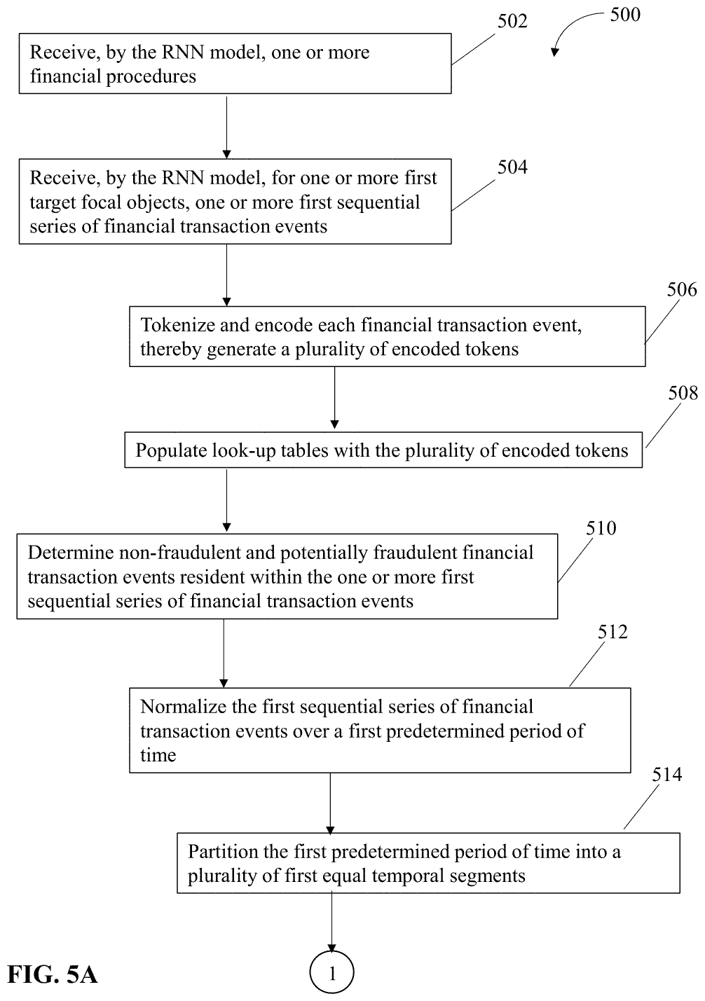

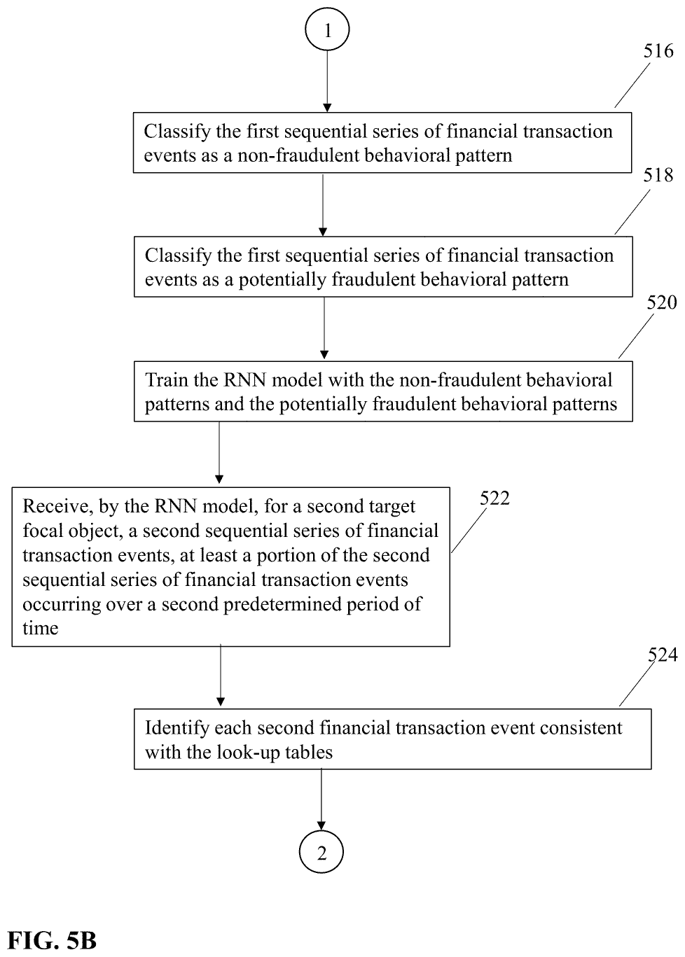

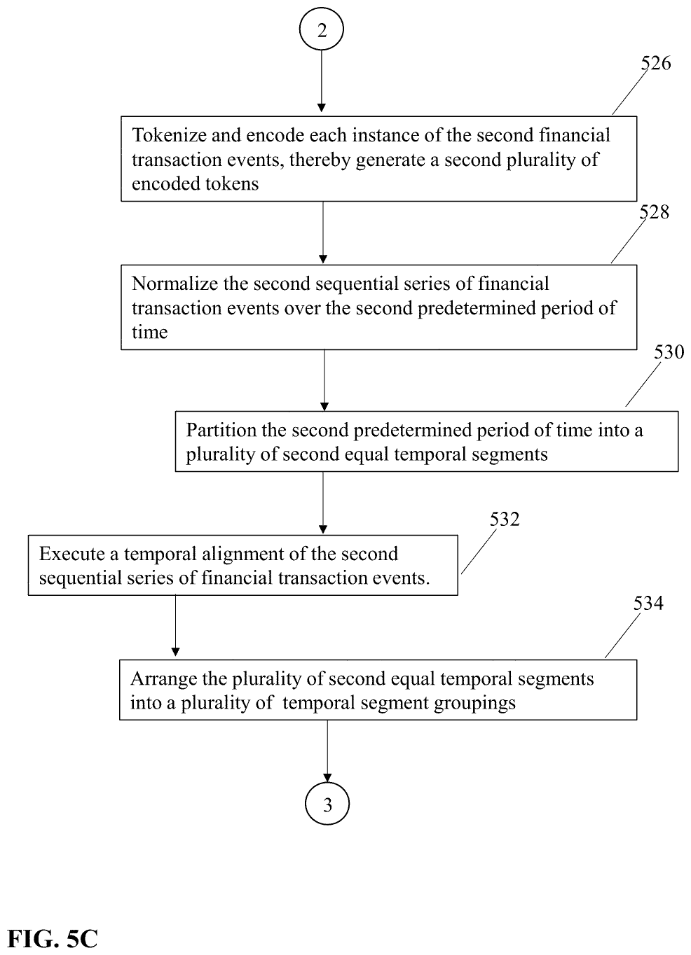

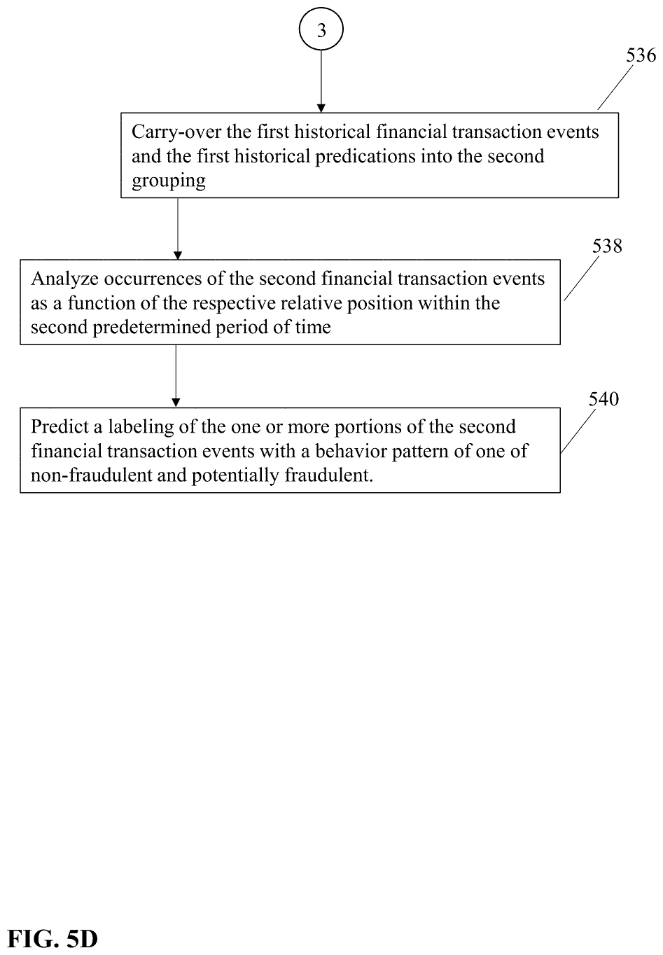

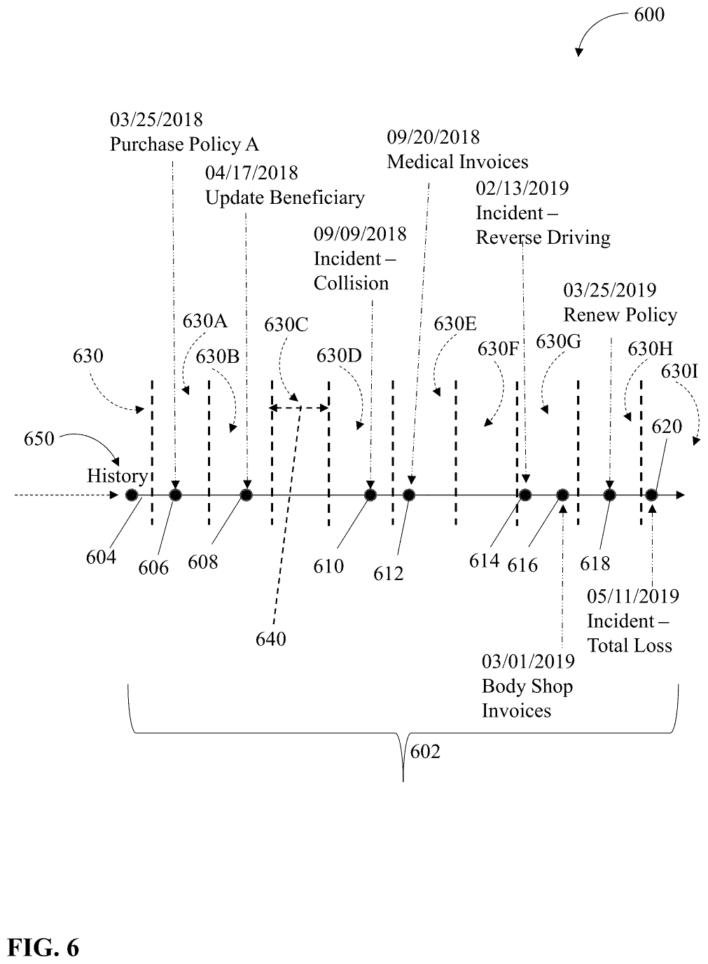

In one or more embodiments, behavior classification and prediction engine 420 is resident within the memory device 406. The behavior classification and prediction engine 420 includes one or more RNN algorithms 430 (only one shown) and one or more RNN models 440 (only one shown). The RNN algorithms 430 and the RNN model 440 are discussed further herein. Also, in at least some embodiments, the data storage system 408 stores data including, without limitation, financial procedures 450 and financial transaction events 460. The financial procedures 450 include those procedures, policies, requirements, etc. for the business entity operating the system 400. The financial transaction events 460 are discussed further with respect to FIGS. 5 and 6. The financial procedures 450 and financial transaction events 460 may be ingested by the RNN model 440. In some embodiments, the financial transaction events 460 are tokenized and encoded to generate encoded tokens 470 that may also be ingested by the RNN model 440, where the encoded tokens 470 may be maintained within one or more look-up tables 480 also stored within the data storage system 408.

Referring to FIG. 5, a flowchart is provided illustrating a process 500 for leveraging the RNN algorithm 430 to classify behaviors and predictions through processing temporal financial features. Also, referring to FIG. 4, in one or more embodiments, the process 500 includes receiving 502, by the RNN model 440 one or more financial procedures 450. The process 500 further includes receiving 504, by the RNN model 440, for one or more first target focal objects, one or more first sequential series of financial transaction events 460. The first target focal objects may be any economic entity, e.g., and without limitation, individuals, small businesses, and large corporations. The entities that may execute the process 500 includes business entities, such as, without limitation, insurance companies and banking institutions. Since the data for the first target focal objects will be used as training data for the RNN model 440, the more financial transaction events 460 data from as many sources and types of target focal objects, the better. Each of the financial transaction events are tokenized and encoded 506 to generate a plurality of encoded tokens 470, where one or more look-up tables 480 are populated 508 with the plurality of encoded tokens. The encoded tokens 470 facilitate the sequential processing through a segmented and temporal alignment thereof.

In at least some embodiment, the process 500 further includes determining 510 non-fraudulent and potentially fraudulent financial transactions resident within the one or more first sequential series of financial transaction events 460. In order to facilitate the determination operation 510, at least a portion of the first sequential series of financial transaction events 460 are temporally normalized 512 over a first predetermined period of time. The first determined period of time is any period that enables operation of the system 400 as described herein. The normalization operation 512 includes partitioning 514 the first predetermined period of time into a plurality of first equal temporal segments. At least a portion of the plurality of first equal temporal segments are representative of the one or more first sequential series of financial transaction events 460 residing therein. The normalization operation 512 and the partitioning operation 514 are discussed further with respect to FIG. 6 herein.

In embodiments, the process 500 also includes classifying 516, as a function of the financial procedures 450, at least a first portion of the first sequential series of financial transaction events as a non-fraudulent behavioral pattern and classifying 518 at least a second portion of the first sequential series of financial transaction events as a potentially fraudulent behavioral pattern. Each verifiable instance of the non-fraudulent behavioral patterns and the potentially fraudulent behavioral patterns, as well as each verifiable instance of the respective financial transaction events 460 are labeled respectively. The RNN model 440 is trained 520 with the non-fraudulent behavioral patterns and the respective financial transaction events 460 and the potentially fraudulent behavioral pattern and the respective financial transaction events 460. A portion of the training operation 520 includes training the RNN model 440 with temporal details of the behavior patterns and respective events with respect to temporal dimensions such as, and without limitation, the respective time scales and frequencies of occurrence.

In at least some embodiments, the process 500 includes receiving 522, by the RNN model 440, for a second target focal object, a second sequential series of financial transaction events 460, at least a portion of the second sequential series of financial transaction events 460 occurring over a second predetermined period of time. In addition to continuing to refer to FIG. 5, referring to FIG. 6, a graphical representation is provided illustrating an example embodiment of a normalized timeline 600.

In one or more embodiments, as shown in FIG. 6, the second sequential series of financial transaction events 602 include a timeline 604 to represent the second period of time, where the target focal object is an individual with an automobile insurance policy. The second sequential series of financial transaction events 602 are included in the financial transaction events 460 (shown in FIG. 4). The length of the timeline 604 and the associated time span represented by the timeline 604 are user selectable and will remain the same within one modeling cycle. Along the timeline 604 the plurality of second financial transaction events 602 are plotted. In the example embodiment shown in FIG. 6, the plurality of second financial transaction events 602 includes Purchase Policy A 606 on Mar. 25, 2018 and Update Beneficiary 608 on Apr. 17, 2018. The plurality of second financial transaction events 602 also includes Incident—Collision 610 on Sep. 9, 2018 and Medical Invoices 612 on Sep. 20, 2018. The plurality of second financial transaction events 602 further includes Incident—Reverse Driving 614 on Feb. 13, 2019 and Body Shop Invoices 616 on Mar. 1, 2019. Moreover, the plurality of second financial transaction events 602 includes Renew Policy 618 on Mar. 25, 2019 and Incident—Total Loss 620 on May 11, 2019. Each of the second financial transaction events 606-620 are identified 524 from data retained within the aforementioned look-up tables. In the circumstance that some events are not identified from the look-up tables, the user will skip and drop those events or encode them into a default token (e.g., out of vocabulary, also referred to as OOV). In addition, each of the second financial transaction events 606-620 are tokenized and encoded 526 to generate a plurality of encoded tokens, where the encoded tokens facilitate the sequential processing through a segmented and temporal alignment thereof.

In some embodiments, the temporal sequence of the financial transaction events 606-620 over the second period of time are analyzed as a function of the sequence of each to determine potential fraudulent activities, e.g., and without limitation, if the temporal pattern of the receipt of medical invoices 612 came before the incident—collision 610, the reverse of the expected pattern, such a circumstance would warrant further investigation into potentially fraudulent activities. In addition to the data shown in FIG. 6, other data received includes, without limitation, vehicle usage such as primarily long distance driving, short distance driving, commuting car, business car, or transportation service.

In one or more embodiments, at least a portion of the second sequential series of financial transaction events are temporally normalized 528 over the second period of time as represented by the timeline 604. The normalization operation 528 includes partitioning 530 the second predetermined period of time into a plurality of second equal temporal segments, hereon referred to as buckets 630A, 630B, 630C, 630D, 630E, 630F, 630G, 630H, and 630I, and collectively as buckets 630. Each of the buckets 630 has a temporal length 640 (only bucket 630C shown with the temporal length of 640), i.e., each of the buckets have a substantially identical temporal length 640. The buckets 630 are representative of the one or more second sequential series of financial transaction events 602 residing therein. The overall length of the timeline 604, the number of buckets 630, and the temporal length 640 are user configurable features (also known as hyperparameters). The temporal length 640 of the buckets 630 may be as large or as small as is useful and/or relevant. However, as the temporal length 640 of the buckets 630 decreases, the number of buckets 630 increases, thereby increasing processing time and resources while decreasing processing efficiency. As shown in FIG. 6, the positioning of the second sequential series of financial transaction events 602 as a function of the buckets 630 is not to scale to provide clarity. Accordingly, the partitioning operation 530 facilitates analyzing each of the target focal objects in the inventory of target focal objects, regardless of their nature, with different time scales, frequencies, and granularities.

In at least some embodiments, the process 500 further includes executing 532 a temporal alignment of the second sequential series of financial transaction events 602. The temporal alignment includes positioning the financial transaction events 602 sequentially along the timeline 604 to facilitate identifying one or more sequences thereof. The financial transaction events of Collision 610 on Sep. 9, 2018 and Medical Invoices 612 on Sep. 20, 2018 appear in adjacent buckets 630D and 630E, respectively. However, such placement in different buckets 630D and 630E is due to the temporal length 640 of the buckets 630 D and 630E and the temporal relationship between financial transaction events 610 and 612 provides at least some context that the two events are related. Buckets 630C and 630F are empty and empty buckets provide important information that includes, without limitation, apparent extended time between financial transaction events and at least slightly increased emphasis on those buckets that include financial transaction events.

The behavior classification and prediction engine 420, including the RNN model 440 embedded within the RNN algorithm 430, is configured and trained to recognize patterns in the sequences of the financial transaction events 602, where anomalous sequences and potentially fraudulent activities will be flagged based on the training operation 520. In some embodiments, the number of unfortunate events in the approximate 14-month time span of the timeline 604 may not only be indicative of a poor driving record, but may also qualify as a series of anomalous events that may require further scrutiny.

As shown in FIG. 6, the approximately 14-month timeline 604 is divided into 9 buckets 630. In some embodiments, the timeline 604 may be truncated at the natural end of the insurance policy life cycle, which may be the next financial transaction event 602 after the Incident—Total Loss 620 on May 11, 2019 financial transaction event. However, in some embodiments, the timeline 604 may be much longer, including extending over many years. For such instances, the timeline 604 may be divided across a number of temporal segment groupings. Therefore, the temporal alignment execution operation 532 includes arranging 534 the plurality of second equal temporal segments, i.e., the buckets 630 into a plurality of temporal segment groupings. For example, and without limitation, a five-year timeline may be divided into five one-year timelines where the plurality of temporal segment groupings includes a first grouping representing the first year that is temporally followed by a second grouping representing the second year, and so on. The first grouping for the first year includes first historical financial transaction events representative of a first portion of the second sequential series of financial transaction events. The first grouping may also include first historical predications of the labeling of the first portion of the second financial transaction events that would be applied based on the training operation 520. The second grouping includes second historical financial transaction events representative of a second portion of the second sequential series of financial transaction events. The second grouping may also include second historical predications of the labeling of the second portion of the second financial transaction events that would be applied based on the training operation 520.

In some embodiments, the temporal alignment execution operation 532 includes carrying-over 536 the first historical financial transaction events and the first historical predications into the second grouping. As shown in FIG. 6, a history 650 that includes all of the previous financial transaction events and transactions is positioned at the input of the first bucket 630A. Similarly, the financial transaction events 602 are added to the history 650 at the end of the bucket 630I, such that the updated history 650 will be used as an input to the next temporal segment grouping. The history 650 may be used to make predictions with respect to the next temporal segment grouping.

In one or more embodiments, the RNN model 440 is configured to ingest the financial transaction events 602, including the history 650, analyze 538 occurrences of the second financial transaction events 602 as a function of the respective relative position within the second predetermined period of time, and predict 540 a labeling of the one or more portions of the second financial transaction events with a behavior pattern of one of non-fraudulent and potentially fraudulent.

The system, computer program product, and method as disclosed herein facilitates overcoming the disadvantages and limitations of known RNNs with respect to providing a mechanism to process financial procedures with temporal features, where the temporal features are derived from the detection and labeling of temporal related patterns in light of the financial procedure with a RNN. In general, industries such as, and without limitation, banking and insurance, may process temporal financial activities on target focal objects to predict behaviors and pattern labels. The temporal features are not analyzed exclusively, and the sequence and target alignment of the temporal aspects of the event are analyzed in combination. Moreover, the partitioning operations described herein facilitate analyzing each of the target focal objects in the inventory of target focal objects, regardless of their nature, with different time scales, frequencies, and granularities. Accordingly, significant improvements to known RNN-based systems are realized through the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
one or more processing devices and at least one memory device operably coupled to the one or more processing devices;
a recurrent neural network (RNN) model resident within the at least one memory device, wherein the one or more processing devices are configured to:
receive, by the RNN model, for one or more first target focal objects, one or more first sequential series of financial transaction events;
determine non-fraudulent and potentially fraudulent financial transactions resident within the one or more first sequential series of financial transaction events;
classify at least a first portion of the one or more first sequential series of financial transaction events as a non-fraudulent behavioral pattern;
classify at least a second portion of the one or more first sequential series of financial transaction events as a potentially fraudulent behavioral pattern;
train the RNN model with the non-fraudulent behavioral pattern and the potentially fraudulent behavioral pattern;
receive, by the RNN model, for a second target focal object, a second sequential series of financial transaction events, at least a portion of the second sequential series of financial transaction events occurring over a first predetermined period of time;
normalize the second sequential series of financial transaction events, comprising partitioning the first predetermined period of time into a plurality of first equal temporal segments, wherein at least a portion of the plurality of first equal temporal segments are representative of one or more portions of the second sequential series of financial transaction events residing therein; and
predict a labeling of the one or more portions of the second sequential series of financial transaction events with a behavior pattern of one of non-fraudulent and potentially fraudulent.

2. The system of claim 1, wherein the one or more processing devices are further configured to:
normalize the one or more first sequential series of financial transaction events, at least a portion of the one or more first sequential series of financial transaction events occurring over a second predetermined period of time.

3. The system of claim 2, wherein the one or more processing devices are further configured to:
partition the second predetermined period of time into a plurality of second equal temporal segments, wherein at least a portion of the plurality of second equal temporal segments are representative of the one or more first sequential series of financial transaction events residing therein.

4. The system of claim 1, wherein the one or more processing devices are further configured to:
analyze occurrences of the second financial transaction events as a function of a respective relative position within the first predetermined period of time.

5. The system of claim 1, wherein the one or more processing devices are further configured to:
tokenize and encode each financial transaction event of the one or more first sequential series of financial transaction events, thereby to generate a plurality of encoded tokens; and
populate one or more look-up tables with the plurality of encoded tokens.

6. The system of claim 1, wherein the one or more processing devices are further configured to:
execute a temporal alignment of the second sequential series of financial transaction events.

7. The system of claim 1, wherein the one or more processing devices are further configured to:
arrange the plurality of first equal temporal segments into a plurality of temporal segment groupings, the plurality of temporal segment groupings includes a first grouping temporally followed by a second grouping, wherein:
the first grouping includes one or more of:
first historical financial transaction events representative of a first portion of the second sequential series of financial transaction events; and
first historical predications of the labeling of the first portion of the second financial transaction events;
the second grouping includes one or more of:
second historical financial transaction events representative of a second portion of the second sequential series of financial transaction events; and
second historical predications of the labeling of the second portion of the second sequential series of financial transaction events; and
carry-over the first historical financial transaction events and the first historical predications into the second grouping.

8. A computer program product, comprising:
one or more computer readable storage media; and
program instructions collectively stored on the one or more computer storage media, the program instructions comprising:
program instructions to receive, by a recurrent neural network (RNN) model, for one or more first target focal objects, one or more first sequential series of financial transaction events;
program instructions to determine non-fraudulent and potentially fraudulent financial transactions resident within the one or more first sequential series of financial transaction events;
program instructions to classify at least a first portion of the one or more first sequential series of financial transaction events as a non-fraudulent behavioral pattern;
program instructions to classify at least a second portion of the one or more first sequential series of financial transaction events as a potentially fraudulent behavioral pattern;
program instructions to train the RNN model with the non-fraudulent behavioral pattern and the potentially fraudulent behavioral pattern;
program instructions to receive, by the RNN model, for a second target focal object, a second sequential series of financial transaction events, at least a portion of the second sequential series of financial transaction events occurring over a first predetermined period of time;
program instructions to normalize the second sequential series of financial transaction events, comprising partitioning the first predetermined period of time into a plurality of first equal temporal segments, wherein at least a portion of the plurality of first equal temporal segments are representative of one or more portions of the second sequential series of financial transaction events residing therein; and
program instructions to predict a labeling of the one or more portions of the second sequential series of financial transaction events with a behavior pattern of one of non-fraudulent and potentially fraudulent.

9. The computer program product of claim 8, further comprising:
program instructions to normalize the one or more first sequential series of financial transaction events, at least a portion of the one or more first sequential series of financial transaction events occurring over a second predetermined period of time, such normalization of the one or more first sequential series of financial transaction events including partitioning the second predetermined period of time into a plurality of second equal temporal segments, wherein at least a portion of the plurality of second equal temporal segments are representative of the one or more first sequential series of financial transaction events residing therein.

10. The computer program product of claim 8, further comprising:
program instructions to analyze occurrences of the second financial transaction events as a function of a respective relative position within the first predetermined period of time.

11. The computer program product of claim 8, further comprising:
program instructions to tokenize and encode each financial transaction event of the one or more first sequential series of financial transaction events, thereby to generate a plurality of encoded tokens; and
program instructions to populate one or more look-up tables with the plurality of encoded tokens.

12. The computer program product of claim 8, further comprising:
program instructions to execute a temporal alignment of the second sequential series of financial transaction events.

13. The computer program product of claim 8, further comprising:
program instructions to arrange the plurality of first equal temporal segments into a plurality of temporal segment groupings, the plurality of temporal segment groupings includes a first grouping temporally followed by a second grouping, wherein:
the first grouping includes one or more of:
first historical financial transaction events representative of a first portion of the second sequential series of financial transaction events; and
first historical predications of the labeling of the first portion of the second financial transaction events;
the second grouping includes one or more of:
second historical financial transaction events representative of a second portion of the second sequential series of financial transaction events; and
second historical predications of the labeling of the second portion of the second financial transaction events; and
carry-over the first historical financial transaction events and the first historical predications into the second grouping.

14. A computer-implemented method comprising:
receiving, by a recurrent neural network (RNN) model, for one or more first target focal objects, one or more first sequential series of financial transaction events;
determining non-fraudulent and potentially fraudulent financial transactions resident within the one or more first sequential series of financial transaction events;
classifying at least a first portion of the one or more first sequential series of financial transaction events as a non-fraudulent behavioral pattern;
classifying at least a second portion of the one or more first sequential series of financial transaction events as a potentially fraudulent behavioral pattern;
training the RNN model with the non-fraudulent behavioral pattern and the potentially fraudulent behavioral pattern;
receiving, by the RNN model, for a second target focal object, a second sequential series of financial transaction events, at least a portion of the second sequential series of financial transaction events occurring over a first predetermined period of time;
normalizing the second sequential series of financial transaction events, comprising partitioning the first predetermined period of time into a plurality of first equal temporal segments, wherein at least a portion of the plurality of first equal temporal segments are representative of one or more portions of the second sequential series of financial transaction events residing therein; and
predicting a labeling of the one or more portions of the second sequential series of financial transaction events with a behavior pattern of one of non-fraudulent and potentially fraudulent.

15. The method of claim 14, wherein determining non-fraudulent and potentially fraudulent financial transactions comprises:
normalizing the one or more first sequential series of financial transaction events, at least a portion of the one or more first sequential series of financial transaction events occurring over a second predetermined period of time.

16. The method of claim 15, wherein normalizing the one or more first sequential series of financial transaction events comprises:
partitioning the second predetermined period of time into a plurality of second equal temporal segments, wherein at least a portion of the plurality of second equal temporal segments are representative of the one or more first sequential series of financial transaction events residing therein.

17. The method of claim 14, wherein predicting the labeling comprises:
analyzing occurrences of the second financial transaction events as a function of a respective relative position within the first predetermined period of time.

18. The method of claim 14, wherein receiving the one or more first sequential series of financial transaction events comprises:
tokenizing and encoding each financial transaction event of the one or more first sequential series of financial transaction events, thereby generating a plurality of encoded tokens; and
populating one or more look-up tables with the plurality of encoded tokens.

19. The method of claim 14, wherein normalizing the second sequential series of financial transaction events comprises:
executing a temporal alignment of the second sequential series of financial transaction events.

20. The method of claim 14, wherein partitioning the first predetermined period of time into the plurality of first equal temporal segments comprises:
arranging the plurality of first equal temporal segments into a plurality of temporal segment groupings, the plurality of temporal segment groupings includes a first grouping temporally followed by a second grouping, wherein:
the first grouping includes one or more of:
first historical financial transaction events representative of a first portion of the second sequential series of financial transaction events; and
first historical predications of the labeling of the first portion of the second financial transaction events;
the second grouping includes one or more of:
second historical financial transaction events representative of a second portion of the second sequential series of financial transaction events; and
second historical predications of the labeling of the second portion of the second sequential series of financial transaction events; and
carrying-over the first historical financial transaction events and the first historical predications into the second grouping.
